(19) United States
(12) Patent Application Publication
(10) Pub. No.: US 2016/0202358 A1
(43) Pub. Date: Jul. 14, 2016

(54) SATELLITE POSITIONING RECEIVER INTEGRATED WITH HIGH-PRECISION POSITIONING APPLICATION SYSTEM

(71) Applicant: COMNAV TECHNOLOGY LTD., Shanghai (CN)

(72) Inventors: XINGWEI DAI, Shanghai (CN); YONGQUAN WANG, Shanghai (CN); YANTAO TIAN, Shanghai (CN)

(21) Appl. No.: 14/913,127

(22) PCT Filed: Feb. 27, 2014
(86) PCT No.: PCT/CN2014/072651

§ 371 Date: Feb. 19, 2016

(30) Foreign Application Priority Data
Aug. 27, 2013 (CN) 201310379754.8

(51) Int. Cl. G01S 19/14

(52) U.S. Cl. CPC G01S 19/14

(57) ABSTRACT

A satellite positioning receiver integrated with high-precision positioning application system, comprising two interconnected modules: a satellite positioning receive and process module used for receiving and processing satellite positioning signals, and a satellite positioning application system module communicating with a user terminal. The satellite positioning receiver integrated with high-precision positioning application system integrates the satellite positioning function and the application function in a single receiver circuit board, allowing a terminal device having a standard Web browser and any operating system can access a satellite positioning receiver to acquire the satellite positioning function and application function furthermore, any mobile terminal can access the satellite positioning receiver to operate or provide a web service development interface for secondary development, thus realizing customized development of various industry applications and having a broader application range.

### FIELD OF TECHNOLOGY

This invention relates to satellite positioning field, especially relates to satellite positioning receiver field, which is a satellite positioning receiver integrated with high-precision positioning application system.

### DESCRIPTION OF RELATED ARTS

Currently, the industry application systems of high-precision satellite positioning system is developed in the method of separating satellite positioning receiver from computer with applications system or electronic handbook, as shown in FIG. 1 of the blocks diagram of the current satellite positioning receiver. Since there are various hardware environments for running the application system, such as Windows tablet PC, Android mobile terminal, Windows PC machine, Linux computers etc, different applications have to be developed to be compatible with the hardware environment and operating system, which results in the main problems as follows:

1. Since the satellite positioning receiver is only with spatial coordinates sampling function, the spatial information application systems in the corresponding operating system environments have to be developed, which increases the developing efforts, however can't achieve cross-platform operation.

2. The data collected by the satellite positioning receiver have to be transferred to a mobile terminal application system for application system development, which increases efforts of developing additional function of communication with various devices. Meanwhile the information interaction between the receiver and various devices results in errors and instability of data communication.

3. Since the current industry satellite positioning data collection systems widely uses dedicated and special mobile terminal, the terminal equipment can't be changed freely, which results in a high cost for upgrading the system and a narrow application range.

### SUMMARY OF THE INVENTION

The purpose of this invention is to overcome the disadvantages of the prior art by providing a satellite positioning receiver integrated with high-precision positioning application system for integrating satellite positioning function and application function into the receiver without the limitation of the operating system, with simple structure, with applicability to a variety of terminal equipment and with a broader applications range.

To achieve the above purpose, the satellite positioning receiver integrated with high-precision positioning application system of this invention is with the structure that:

the satellite positioning receiver integrated with high-precision positioning application system is characterized in that: the receiver comprises:

a satellite positioning receive and process module of for receiving and processing the satellite positioning signals;

a satellite positioning application system module, which is connected with the satellite positioning receive and process module; the satellite positioning application system module of is for communicating with users terminal.

Preferably, the satellite positioning application system module is the Web application system module.

More preferably, the users terminal communicates with the satellite positioning application system module by logging in the browser or Web service.

More preferably, Web application system module is based on Java application server.

Furthermore, the Java application server is based on Linux operation system.

Preferably, the satellite positioning application system module communicates with the users terminal via Wifi, 3G networks or Bluetooth.

Preferably, the users terminal is the terminal with Windows Mobile operation system, Windows CE operation system, various versions of Windows operation systems, IOS operation system or Android operation terminal system.

Preferably, the satellite positioning receive and process module and the satellite positioning application system module are set on the same circuit board.

For this invention, the satellite positioning receiver integrated with high-precision positioning application system has the following beneficial effects:

(1) The satellite positioning function and application function are integrated into a single receiver circuit board, which allows a terminal device with a standard Web browser access satellite positioning receiver to acquire a satellite positioning applications function without the limitation of the operating system. Therefore the electronic handbook function such as data collection, setting out needn't a dedicated handheld device, and any mobile terminal can be connected with a satellite positioning receiver to work.

(2) The information exchange and system configuration function of the receiver in the way of Web Service can support secondary development of application systems and allows developing Java service program according to application needs and deploying them to the receiver in order to expand the satellite positioning receiver application function. Additionally, the secondary development in the way of Web Service can also deploy the function in a specific application system. The general-purpose operating system Linux as the fundamental operating platform of the satellite positioning receiver is with a broader of applications range.

### BRIEF DESCRIPTION OF THE DRAWINGS

FIG. 1 is the blocks diagram of the current satellite positioning receiver.

FIG. 2 is the blocks diagram of the satellite positioning receiver integrated with high-precision positioning application system of this invention.

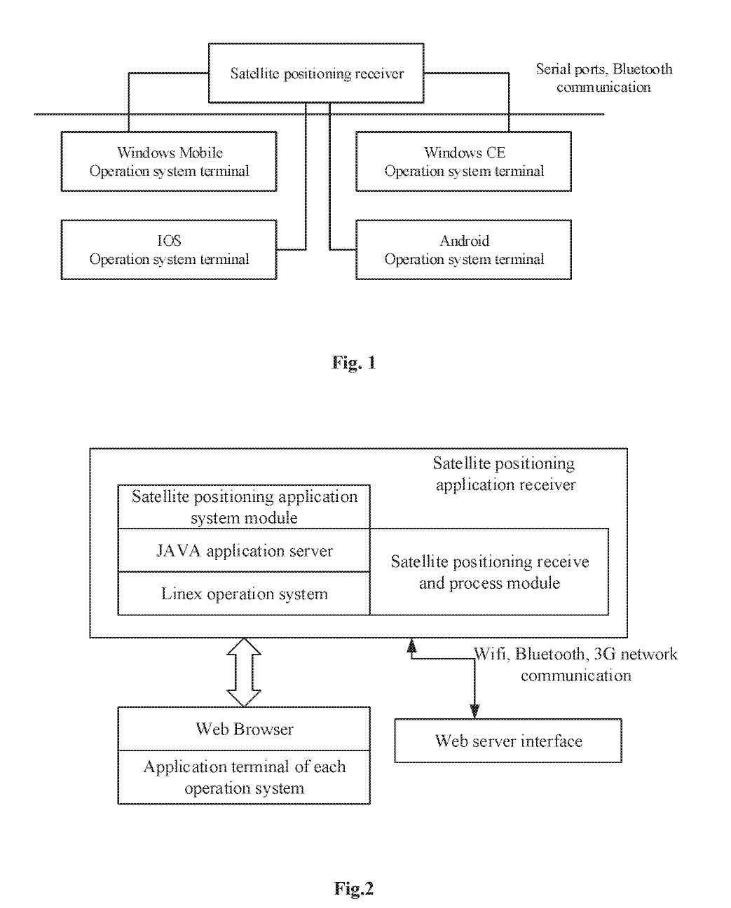

### DETAILED DESCRIPTION OF THE PREFERRED EMBODIMENT

In order to clearly illustrate the technical content of this invention, the embodiment below is for further describing.

This invention provides an integrated development method for the satellite positioning receiver integrated with high-precision positioning application system to overcome the disadvantages in the current industry, which integrates the application system function with satellite positioning function to form a complete and integrated solution integrating satellite positioning and application system, software and hardware. This system can be widely applied in any mobile terminals, desktop terminals and remote terminals.

FIG. 2 is the blocks diagram of the satellite positioning receiver integrated with high-precision positioning application system of this invention.

The basic principles of the design are: the high-performance mobile terminal processor is used for building the data processing hardware platform of the satellite positioning receiver, on which a Linux operating system and a satellite positioning receive and process module are integrated; service application oriented Java server is built on Linux operating systems; the fundamental satellite positioning application system module is built on a Java server, which can two-way interact with satellite positioning receive and process module in one hand, and can develop various application system according to different application industry in another hand. The application system module runs in the way of Web Service. Not only web browser can be used for system application, but also Web Service can be used to provide function of end users' secondary development.

The integrated application system module runs in a way of standard Web service by providing a URL (Uniform Resource Locator) address, with which various operating systems terminals can use the system on the Web browser. It can also be accessed in the way of Web Service, which enables various applications run on different machines directly to interact with the application background without the additional and dedicated third-party software or hardware to implement data exchanging and integrating. The integrated receiver solution can use not only Wifi and 3G networks but also the Bluetooth in TCP/IP approach for communication.

For this invention, the satellite positioning receiver integrated with high-precision positioning application system has the following beneficial effects:

(1) The satellite positioning function and application function are integrated into a single receiver circuit board, which allows a terminal device with a standard Web browser access satellite positioning receiver to acquire a satellite positioning applications function without the limitation of the operating system. Therefore the electronic handbook function such as data collection, setting out needn't a dedicated handheld device, and any mobile terminal can be connected with a satellite positioning receiver to work.

(2) The information exchange and system configuration function of the receiver in the way of Web Service can support secondary development of application systems and allows developing Java service program according to application needs and deploying them to the receiver in order to expand the satellite positioning receiver application function. Additionally, the secondary development in the way of Web Service can also deploy the function in a specific application system. The general-purpose operating system Linux as the fundamental operating platform of the satellite positioning receiver is with a broader of applications range.

This invention has been described with reference to certain embodiments. However, various changes may be made and equivalents may be substituted without departing from the scope of the present invention. Therefore, this invention is not limited to the particular embodiment disclosed, but that this invention includes all embodiments falling within the scope of the appended claims.

I claim:

1. A satellite positioning receiver integrated with high-precision positioning application system, characterized in that the receiver comprises:
a satellite positioning receive and process module for receiving and processing the satellite positioning signals.
a satellite positioning application system module, which is connected with the satellite positioning receive and process module of; the satellite positioning application system module is for communicating with users terminal.

2. The satellite positioning receiver integrated with high-precision positioning application system according to claim 1, wherein the satellite positioning application system module is the Web application system module.

3. The satellite positioning receiver integrated with high-precision positioning application system according to claim 2, wherein the users terminal communicates with the satellite positioning application system module by logging in the browser or Web service.

4. The satellite positioning receiver integrated with high-precision positioning application system according to claim 2, wherein the Web application system module is based on Java application server.

5. The satellite positioning receiver integrated with high-precision positioning application system according to claim 4, wherein the Java application server is based on Linux operation system.

6. The satellite positioning receiver integrated with high-precision positioning application system according to claim 1, wherein the satellite positioning application system module communicates with the users terminal via Wifi, 3G networks or Bluetooth.

7. The satellite positioning receiver integrated with high-precision positioning application system according to claim 1, wherein the terminal user is the terminal with Windows Mobile operation system, Windows CE operation system, various versions of Windows operation systems, IOS operation system or Android operation terminal system.

8. The satellite positioning receiver integrated with high-precision positioning application system according to claim 1, wherein the satellite positioning receive and process module and the satellite positioning application system module are set on a single circuit board.
